(19) United States
(12) Patent Application Publication
(10) Pub. No.: US 2015/0129787 A1
(43) Pub. Date: May 14, 2015

(54) RETAINER AND O-RING FOR VALVE SEALING

(71) Applicant: DELTROL CONTROLS, Milwaukee, WI (US)

(72) Inventor: Nick William Buettner, Burlington, WI (US)

(73) Assignee: DELTROL CONTROLS, Milwaukee, WI (US)

(21) Appl. No.: 14/533,302

(22) Filed: Nov. 5, 2014

Related U.S. Application Data
(60) Provisional application No. 61/901,605, filed on Nov. 8, 2013.

(51) Int. Cl. F16K 3/24; F16K 27/04; F16K 31/06

(52) U.S. Cl. CPC F16K 3/243; F16K 31/0668; F16K 27/041
USPC 251/129.19; 251/326

(57) ABSTRACT

A system for positioning a seal member on a movable valve stem. The system includes an O-ring surrounding a lower portion of a movable valve stem. A snap-on retaining collar is pushed into place along the valve stem. A lower edge of the collar contacts the O-ring. The interaction between the snap-on collar and the O-ring prevents the O-ring from flexing outwardly and becoming dislodged from the valve stem. The snap-on retaining collar can be formed from various materials, such as but not limited to plastic.

### CROSS-REFERENCE TO RELATED APPLICATION

The present application is based on and claims priority to U.S. Provisional Patent Application Ser. No. 61/901,605 filed Nov. 8, 2013, the disclosure of which is incorporated herein by reference.

### BACKGROUND

The present disclosure generally relates to a dispensing valve. More specifically, the present disclosure relates to a dispensing valve that includes an O-ring retention system to prevent the O-ring from becoming dislodged from a movable valve stem in the dispensing valve.

In a typical construction of dispensing valves, the dispensing valve includes a valve stem that is movable between an open and a closed position. In the closed position, the valve stem prevents the flow of liquid from an inlet to an outlet.

In many dispensing valves, a sealing member, such as an O-ring, is positioned on the valve stem to provide a liquid tight seal between the valve stem and a valve seat when the valve is in a closed position. In applications where the dispensing valve is used with relatively high pressure fluids, the high pressure fluids can force the O-ring off of the valve stem during movement from the closed position to an open position. Therefore, a need exists for a retention system that holds an O-ring on the valve stem during use.

### SUMMARY

The present disclosure relates to a dispensing valve in which an inexpensive O-ring can be purchased in any number of materials, sizes and durometers. The O-ring forms a face seal with a valve seat when the valve stem is in the closed. condition. Typically, O-rings are not used as face seals since the water pressure acts on the O-ring to force it off of the movable valve stem as the movable valve stem is titled off the valve seat. This is primarily true when higher differential pressures are used.

The present disclosure utilizes a snap-on collar that captures the O-ring between the collar and the valve stem. The snap-on collar prevents the O-ring from lifting off of the valve stem during movement of the valve stem between the open and closed conditions.

The present disclosure further relates to a dispensing valve that includes a valve body having an inlet and an outlet. The dispensing valve includes a valve stem that is movable within the valve body between an open position and a closed position. When the valve stem is in the closed position, the valve stem prevents the flow of liquid from the inlet to the outlet. In the open position, the valve stem allows fluid to flow from the inlet to the outlet.

The dispensing valve further includes an O-ring that is mounted to an outer surface of the valve stem. Specifically, the O-ring is received within a sealing groove that is formed in the valve stem at or near an outer end of the valve stem. The resilient nature of the O-ring holds the O-ring within the sealing groove.

In one embodiment of the disclosure, the dispensing valve includes a bias spring that urges the valve stem toward the closed position. In such an embodiment, the dispensing valve includes an actuator that moves the valve stem against the bias force created by the bias spring toward an open position.

The valve stem includes a retaining collar that is snap tit onto the valve stem. When the retaining collar and O-ring are both mounted to the valve stem, the retaining collar at least partially surrounds the O-ring to hold the O-ring in position on the valve stem. The retaining collar is configured to have a bottom end that is generally aligned with an equator of the O-ring to prevent both expansion of the O-ring and restrict the flow of pressurized liquid between the O-ring and the valve stem.

In one embodiment of the disclosure, the retaining collar is formed from a plastic material. The retaining collar can include one or more slots that allow the top end of the collar to flex outward and create a snap fit of the retaining collar onto the valve stem.

Various other features, objects and advantages of the invention will be made apparent from the following description taken together with the drawings.

### BRIEF DESCRIPTION OF THE DRAWINGS

The drawings illustrate the best mode presently contemplated of carrying out the disclosure. In the drawings:

FIG. 1 is an isometric view of a dispensing valve constructed in accordance with the present disclosure;

FIG. 2 is a section view of the dispensing valve in a closed position;

FIG. 3a is a section view of the dispensing valve in the open position;

FIG. 3b is as magnified view of the valve stem in the open position;

FIG. 4a is a section view of the dispensing valve in the closed position;

FIG. 4b is a magnified view showing the valve stem in the closed position;

FIG. 5 is a magnified view illustrating the position of a snap-on collar on the valve stem to retain a sealing O-ring;

FIG. 6 is an isometric view of the snap-on collar shown in FIGS. 5; and

FIG. 7 is a section view of the snap-on collar taken along line 7-7 of FIG. 6.

### DETAILED DESCRIPTION

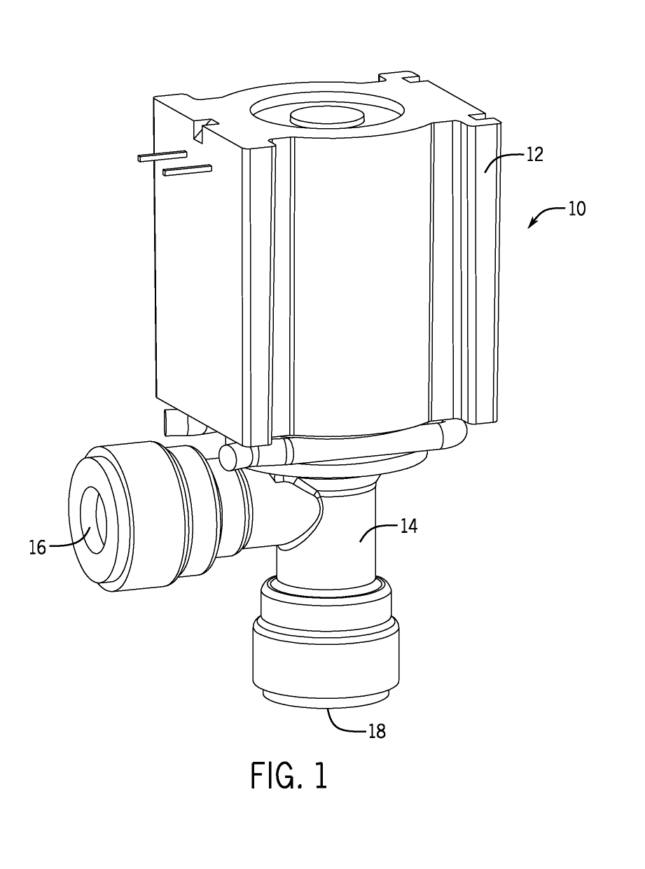

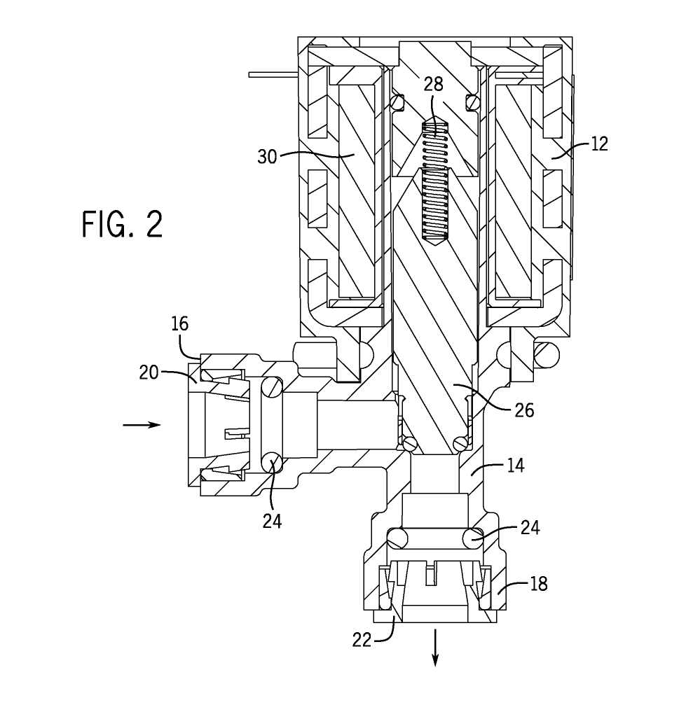

FIG. 1 illustrates a dispensing valve 10 constructed in accordance with the present disclosure. The dispensing valve 10 includes a solenoid actuator 12 mounted on a valve body 14. The valve body 14 includes a fluid inlet 16 that receives a supply of liquid that passes through the valve body 14 and is dispensed from an outlet 18. As best illustrated in FIG. 2, the inlet 16 receives a collet 20 while the outlet 18 receives a similar collet 22. A sealing member, such as an O-ring 24, is positioned within both the inlet 16 and the outlet 18.

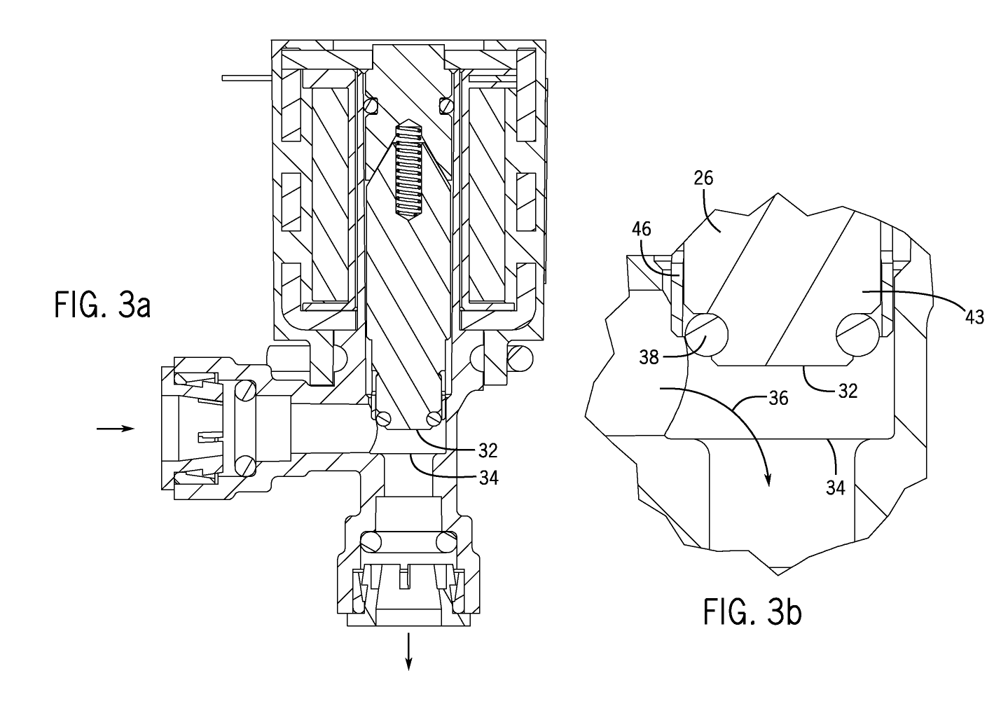

The flow of fluid from the inlet 16 to the outlet 18 is controlled by the position of a movable valve stem 26. The valve stein 26 is biased into the closed position shown in FIG. 2 by a bias spring 28. An electromagnetic coil 30 surrounds the valve stem 26 and can be activated to move the valve stem 26 upward against the bias force created by the spring 28 into an open position, as shown in FIG. 3a. When in the open position, the bottom face surface 32 of the valve stem is spaced above a valve seat 34, as best illustrated in FIG. 3b, to allow fluid flow through the valve body 14. The flow of fluid is illustrated by arrow 36.

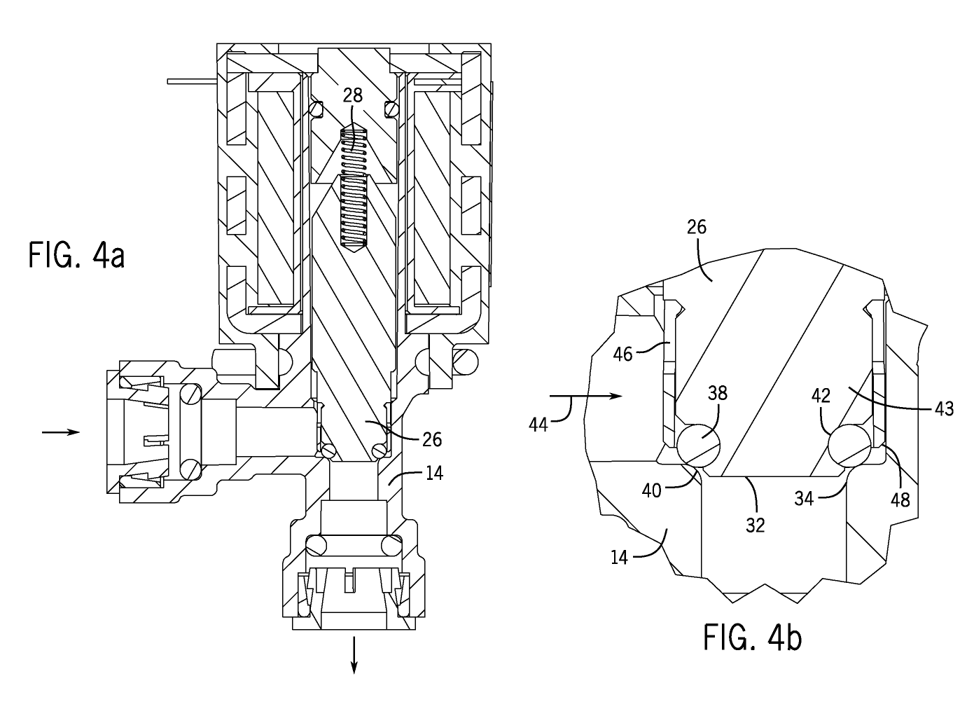

FIGS. 4a and 4b illustrate the valve stem 26 in the closed position. As illustrated best in FIG. 4b, when the valve stem 26 is in the closed position, an O-ring 38 mounted near the end of the valve stem 26 is pressed into contact with a sealing outer edge 40 of the valve body 14 that defines the valve seat 34. The bias force created by the spring 28 provides the required sealing force between the O-ring 38 and the valve seat 34.

As illustrated in FIG. 4b, the O-ring 38 is received within a sealing groove 42 formed at the outer end 43 of the valve stem 26. The resilient nature of the O-ring 38 generally holds the O-ring 38 within the sealing groove 42 during normal conditions, as shown in FIG. 4b.

When the valve stem 26 begins to move upward from the closed position of FIG. 4b to the open position of FIG. 3b, the high pressure flow of fluid, illustrated by arrow 44 in FIG. 4b, contacts the O-ring 38, urging the O-ring to stretch and be pushed off of the outer end 43 of the valve stem 26.

If the O-ring 38 were used alone on the outer end 43 of the valve stem 26, the high pressure fluid flow may cause the O-ring 38 to become separated from the valve stem 26, which would render the dispensing valve inoperable. To address this issue, the valve stem 26 includes a retention system that includes a retaining collar 46. As illustrated in FIG. 4b, a bottom end 48 of the collar extends to the approximate equator of the O-ring 38. The collar 46 thus prevents the high pressure fluid flow from flowing between the O-ring 38 and the sealing groove 42. Thus, the O-ring 38 cannot flex outward and become dislodged from the outer end 43 of the valve stem 26.

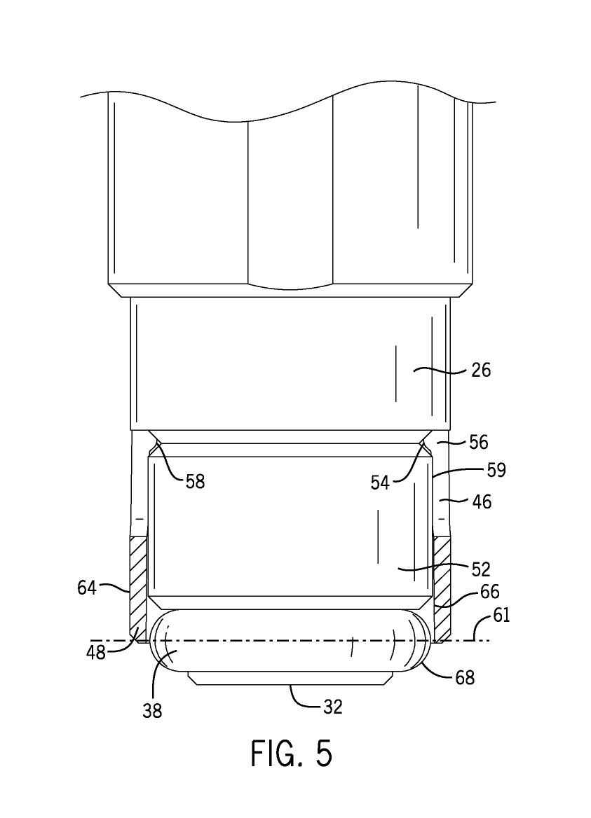

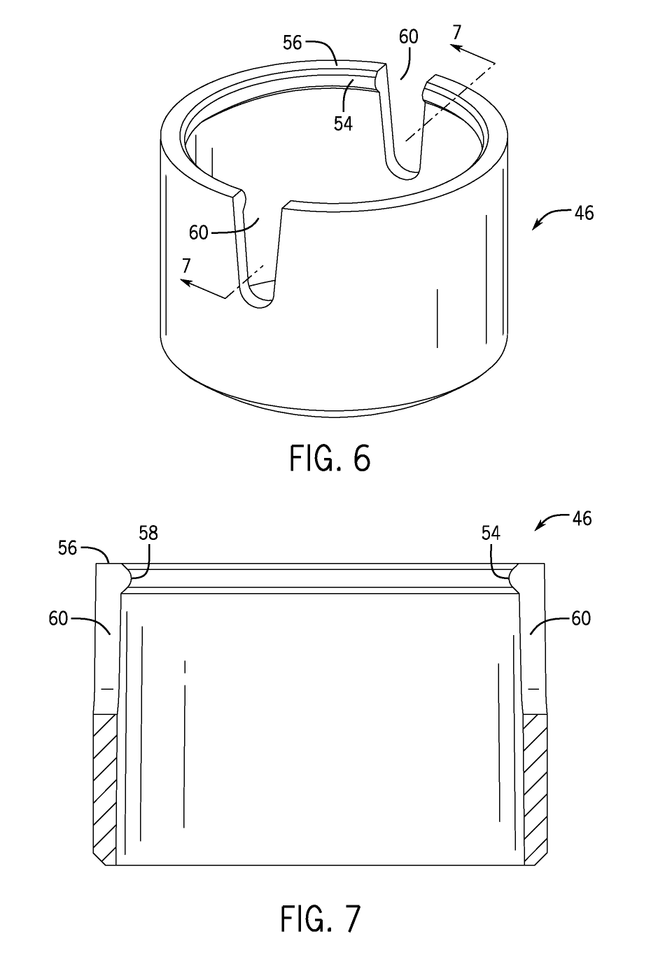

FIG. 5 illustrates the position of the retaining collar 46 along the lower portion 52 of the valve stem 26. As indicated previously, the bottom end 48 of the collar 46 extends to a position approximately aligned with an equator 61 of the O-ring 38. The collar 46 thus prevents the O-ring 38 from flexing and becoming dislodged from the lower portion 52 of the valve stem 26. In the preferred embodiment of the disclosure, the collar 46 includes a protruding finger 54 on the top end 56, as illustrated in FIGS. 5 and 6. The finger 54 is received within a collar groove 58 machined into an outer surface 59 of the valve stem 26. In the embodiment illustrated, the collar 46 is formed from a flexible plastic material, although other materials are contemplated.

As shown in FIG. 6, the collar 46 includes a pair of open slots 60 that allow the top end 56 of the collar 46 to flex outward. The flexing of the collar 46 allows the collar 46 to snap into place along the valve stem 26, as shown in FIG. 5. When in position as shown in FIG. 5, the material properties of the collar 46 hold the protruding finger 54 formed on the top end 56 in the collar groove 58.

The section view of FIG. 7 illustrates the depth of each of the pair of open slots 60. The open slots 60 allow the top end 56 of the collar 46 to expand and snap back into the retaining position shown in FIG. 5. Although the pair of open slots 60 are illustrated in FIGS. 6 and 7, it is contemplated that the open slots 60 could be eliminated if the collar 46 is made of a material that has sufficient resilient properties such that it can flex when pushed onto the lower portion 52 of the valve stem 26 and snap back into the position shown in FIG. 5.

Referring back to FIG. 5, the steps in assembling the valve stem will now be discussed. Initially, the O-ring 38 is pushed onto the valve stem until the O-ring 38 is received within the sealing groove 42 (see FIG. 4b). Once the O-ring 38 is in position, the collar 46 is positioned beneath the valve stem 26. The collar 46 is then aligned with the valve stem and pushed upward. During this movement, the O-ring 38 is received within the open top end and the collar 46 is pushed further upward until the fingers 54 reach the groove 58. Once the fingers 54 reach the collar groove 58, the fingers are received within the collar groove 58 to hold the collar in position as shown.

As discussed previously, the bottom end 48 of the collar is generally aligned with the equator 61 of the O-ring 38. Thus, the outer wall 64 of the collar 46 prevents liquid from directly flowing into contact with the O-ring 38 at a location above the equator 61. In addition, due to the close spacing between the inner surface 66 of the outer wall 64 and the outer surface 68 of the O-ring 38, the collar 46 prevents the O-ring 38 from expanding outward. In this way, the collar 46 prevents the dislodgement of the O-ring 38 from the valve stem 26 during movement of the valve stem from the closed position to the open position.

This written description uses examples to disclose the invention, including the best mode, and also to enable any person skilled in the art to make and use the invention. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

I claim:

1. A dispensing valve, comprising:
a valve body having an inlet and an outlet:
a valve stem movable within the valve body between an open position and a closed position, wherein the valve stem prevents the flow of liquid from the inlet to the outlet in the closed position;
an O-ring mounted to an outer surface of the valve stem; and
a retaining collar received on the valve stem and at least partially surrounding the O-ring.

2. The dispensing Valve of claim 1 wherein the O-ring is received within a sealing groove formed in the valve stem at an outer end of the valve stem.

3. The dispensing valve of claim 2 wherein the retaining collar includes an outer wall defining an open top end, wherein the open top end includes a protruding finger received within a recessed collar groove formed on the valve stem.

4. The dispensing valve of claim 3 wherein the outer wall includes at least one open slot extending into the outer wall from the top end.

5. The dispensing valve of claim 1 wherein the retaining collar is formed from plastic.

6. The dispensing valve of claim 4 wherein a bottom end of the retaining collar is generally aligned with an equator of the O-ring when the retaining collar and O-ring are mounted to the valve stem.

7. The dispensing valve of claim 6 wherein the retaining collar is snap fit onto the valve stem.

8. The dispensing valve of claim 1 wherein the outlet includes a valve seat and the O-ring engages the valve seat when the valve stem is in the closed position.

9. A dispensing valve, comprising:
a valve body having an inlet and an outlet;
a valve stem movable within the valve body between an open position and a closed position, wherein the valve stem prevents the flow of liquid through the valve body from the inlet to the outlet in the closed position;
a bias spring positioned to urge the valve stem into the closed position;
an actuator operable to move the valve stem from the closed position to the open position;
an O-ring mounted to an outer surface of the valve stem, wherein the O-ring engages a valve seat within the valve body when the valve stem is in the closed position; and
a retaining collar received on the valve stem and at least partially surrounding the O-ring.

10. The dispensing valve of claim 9 wherein the O-ring is flexed outward and received within a sealing groove formed in the Naive stem at an outer end of the valve stem.

11. The dispensing valve of claim 10 wherein the retaining collar is snap fit onto the valve stem.

12. The dispensing valve of claim 11 wherein the retaining collar includes a top end having a protruding finger, wherein the protruding finger is received within a recessed collar groove formed on the valve stem.

13. The dispensing valve of claim 12 wherein the retaining collar includes at least one open slot extending from the top end.

14. The dispensing valve of claim 13 wherein the retaining collar is formed from plastic.

15. The dispensing valve of claim 9 wherein a bottom end of the retaining collar is generally aligned with an equator of the O-ring when the retaining collar and the O-ring are mounted to the valve stem.
